(19) United States
(12) Patent Application Publication
(10) Pub. No.: US 2023/0368014 A1
(43) Pub. Date: Nov. 16, 2023

(54) MULTI-CHIPLET ENERGY-EFFICIENT DNN ACCELERATOR ARCHITECTURE

(71) Applicant: Taiwan Semiconductor Manufacturing Company, Ltd., Hsinchu (TW)

(72) Inventors: Kerem Akarvardar, Hsinchu (TW); Rawan Naous, Hsinchu (TW); Xiaoyu Sun, Hsinchu (TW)

(73) Assignee: Taiwan Semiconductor Manufacturing Company, Ltd., Hsinchu (TW)

(21) Appl. No.: 17/740,367

(22) Filed: May 10, 2022

(51) Int. Cl. G06N 3/08; G06K 9/62

(52) U.S. Cl. CPC G06N 3/08; G06K 9/6262; G06K 9/6277; G06K 9/628

(57) ABSTRACT

A design method, an operating method and an electronic system are provided. The method comprises receiving a training dataset having a plurality of training data, wherein each training data is labeled to one of a plurality of classes; selecting at least one first class from the plurality of classes and establishing a first category having the at least one selected first class; training a first model with the training dataset, and using the at least one first class within the first category for verification; and implementing the first model on the accelerator.

### BACKGROUND

With the growing demand on high performance computing (HPC) devices, data latency resulted from accessing weights stored in the DRAM has become one of the major problems to be solved by a skilled person in the art.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a design method of an electronic system in accordance with some embodiments of the present disclosure.

FIG. 2A illustrates a schematic diagram on how the classes are categorized into categories in accordance with some embodiments of the present disclosure.

FIG. 2B illustrates a schematic diagram on a classification result generated by the models in accordance with some embodiments of the present disclosure.

FIG. 3 illustrates an electronic system in accordance with some embodiments of the present disclosure.

FIG. 4A illustrates an operating method of and electronic system in accordance with some embodiments of the present disclosure.

FIG. 4B illustrates an operating method of and electronic system in accordance with some embodiments of the present disclosure.

### DESCRIPTION OF THE EMBODIMENTS

The following disclosure provides many different embodiments, or examples, for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In machine learning, a convolutional neural network (CNN, or ConvNet) is a class of deep, feed-forward artificial neural network that have successfully been applied to analyzing visual imagery or other data. CNNs use a variation ofmultilayer perceptrons designed to require minimal preprocessing. They are also known as shift invariant or space invariant artificial neural networks (SIANN), based on their shared-weights architecture and translation invariance characteristics. CNNs use relatively little pre-processing compared to other image classification algorithms. This means that the network learns the filters that in traditional algorithms were hand-engineered. This independence from prior knowledge and human effort in feature design is a major advantage.

In machine learning, support vector machines (SVMs, also support vector networks) are supervised learning models with associated learning algorithms that analyze data used for classification and regression analysis. Given a set of training examples, each marked as belonging to one or the other of two categories, an SVM training algorithm builds a model that assigns new examples to one category or the other, making it a non-probabilistic binary linear classifier (although methods such as Platt scaling exist to use SVM in a probabilistic classification setting). An SVM model is a representation of the examples as points in space, mapped so that the examples of the separate categories are divided by a clear gap that is as wide as possible. New examples are then mapped into that same space and predicted to belong to a category based on which side of the gap they fall. In addition to performing linear classification. SVMs can efficiently perform a non-linear classification using what is called the kernel trick, implicitly mapping their inputs into high-dimensional feature spaces. When data are not labeled, supervised learning is not possible, and an unsupervised learning approach is required, which attempts to find natural clustering of the data to groups, and then map new data to these formed groups. The clustering algorithm which provides an improvement to the support vector machines is called support vector clustering and is used when data are not labeled or when only some data are labeled as a preprocessing for a classification pass.

Deep learning (also known as deep structured learning or hierarchical learning) is the application of artificial neural networks (ANNs) to learning tasks that contain more than one hidden layer. Deep learning is part of a broader family of machine learning methods based on learning data representations, as opposed to task-specific algorithms. Learning can be supervised, partially supervised or unsupervised. Some representations are loosely based on interpretation of information processing and communication patterns in a biological nervous system, such as neural coding that attempts to define a relationship between various stimuli and associated neuronal responses in the brain.

The learning algorithms may be implemented through neural network-based architectures for computation. The architectures are stored with a model comprising a plurality of weights which are capable to be trained and adapted through learning and verification processes. The trained model may be implemented on image recognition, voice recognition, or other suitable fields to determine whether one of a plurality of predetermined contents is appeared in the image or audio clip. The model may be formed by weight values of random numbers initially, and a training dataset comprising a plurality of data respectively each labeled by a corresponding class may be provided to the model. Each training data may contain, for example, image and/or audio contents to be identified by the model, and each labeled class may be referred as an answer to each training data. When the training data is provided to the model, the neural network performs calculations based on the weights stored in the model and features extracted from the training data to generate a corresponding output. Then, the generated output and the labeled class corresponding to the same training data may be compared to verify whether the computation result is consistent with the labeled class. When it is determined that there is error between the generated output and the labeled class, the weights stored in each model may be adjusted accordingly. In some embodiments, the model is initially stored with weight values of random numbers, and as learning proceeds, the model and the weights stored may be adapted, so error between the output generated by the neural network and the labeled class may be minimized.

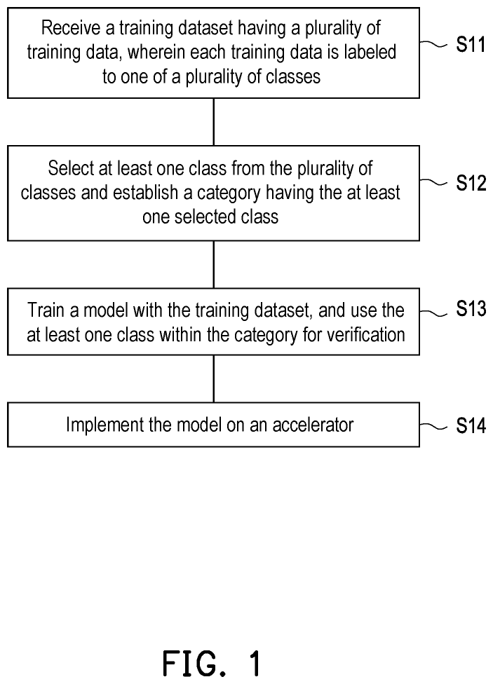

FIG. 1 illustrates a design method of an electronic system in accordance with some embodiments of the present disclosure. The design method comprises steps S11-S14. The design method may be utilized for designing the electronic system capable of performing high performance computing (HPC). For example, the electronic system may be configured to execute an artificial intelligence (AI) algorithm and/or a machine learning (ML) algorithm and/or a deep learning (DL) algorithm, or other suitable algorithms.

The designed electronic system is configured to store a trained classification model, so upon receiving of a data, the electronic system may execute the classification model based on the received data, to generate a classification result for inferring which class the data falls within. The classes to be identified by the classification model are categorized into a plurality of categories, and each category has at least one class. Further, the classification model may be divided into a plurality of models respectively corresponding to the plurality of categories, and thus when executing the classification model, the plurality of models may be executed and each model may generate at least one probability values respectively corresponding to the at least one class falling within each category. As a result, the electronic system designed by the design method is capable of determining which class the data falls within based on the probability values the models generated. By dividing the classification model into multiple models, overall model complexity can be reduced, thereby improving the computation speed and power consumption during computation without deteriorating accuracy.

Each model of the classification model may be a CNN model formed by a plurality of weights. For example, the model may be an AlexNet, LeNet, Visual Geometry Group (VGG), Network in Network (NiN) GoogLeNet, ResNet, DenseNet, MobileNet, ShuffleNet, or other suitable CNN models.

In step S11, a training dataset having a plurality of training data is received. Each training in the training dataset has already been identified and labeled with a corresponding class. Specifically, the training data may be provided to the model to generate a computation result for inferring which class the training data falls within. The corresponding label may be used to verify the computation result, so weights stored in the model may be accommodated or adjusted based on comparison between the computation result and the label. The above-mentioned process may be repeated until the accuracy of the computation result converges or inference accuracy is greater than a predetermined value.

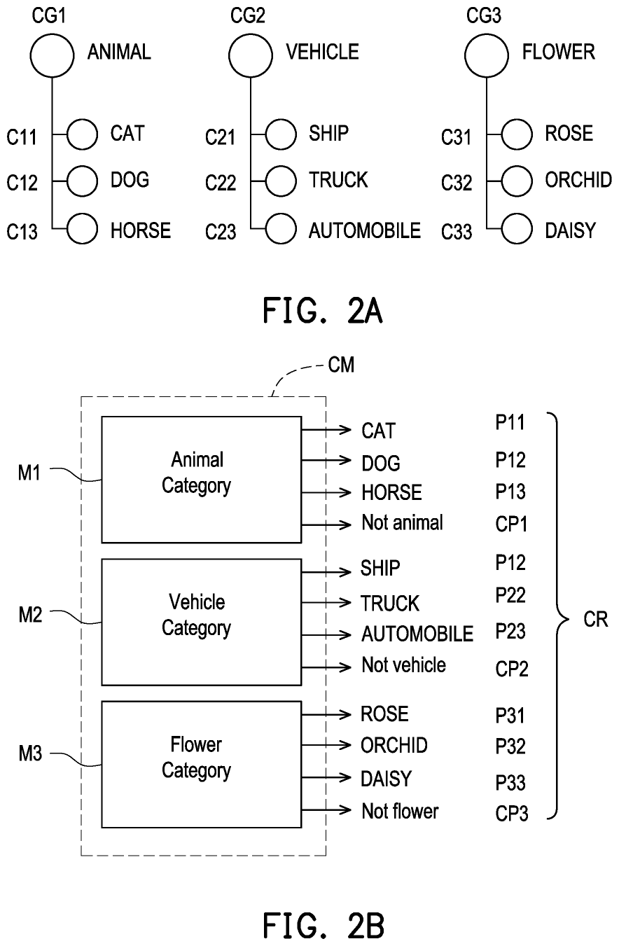

In Step S12, at least one class is selected from the plurality of classes and a first category having the at least one selected class is established. Specifically, at least one class with the same or similar features can be selected and grouped in the same category. FIG. 2A illustrates a schematic diagram on how the classes are categorized into categories in accordance with some embodiments of the present disclosure. In the exemplary embodiment, the model is configured to identify whether a certain object of predetermined classes is appeared in a received image data. Each image data in the training dataset is labeled to one of the nine classes. A total of three categories CG1-CG3 may be established for categorizing the nine classes C11-C33. That is, the cat class C11, the dog class C12, and the horse class C13 are categorized into the animal category CG1. The ship class C21, the truck class C22, and the automobile class C23 are categorized into the vehicle category CG2. The rose class C31, the orchid class C32, and the daisy class C33 are categorized into the flower category CG3. In accordance with the categorization, a category label is attached to each training data based on which category the training data falls within. Therefore, each image data in the training dataset may be labeled to a category corresponding to the class falls within in addition to the class already being labeled. Thus, each class is assigned in a category.

In some embodiments, the categories may be built based on real-world membership of each class. In some embodiments, an input dataset, such as ImageNet, already has categories, and these categories may be adopted.

In step S13, a plurality of models respectively corresponding to the plurality of categories are trained, and each model is trained with the training dataset and verified by the corresponding category with the at least one class falls within the corresponding category. In brief, instead of training a single classification model capable of identifying which class the training data falls within from all classes to be selected, a plurality models respectively corresponding to the plurality of categories are trained. Each model is trained to determine which class the training data falls within from the at least one class of the corresponding category. Since the trained model generates a determination result on each class to be identified by the model, reducing a number of classes to be identified by the model may accordingly reduce model complexity and computation latency. In some embodiments, each model is further trained to generate a determination result on whether the training data falls within the category corresponding to the model.

In some embodiments, the training data in the training dataset is provided to the model for the model to generate inference on which class each training data falls within. Specifically, each model generates inference on which class, among the category corresponding to the model, each training data falls within, and also generates inference on whether the training data falls within the category corresponding to the model. After the inferences are generated, the labels corresponding to the same training dataset is provided to the model for verification. The labels comprising information which class and category the training data corresponds to. Therefore, weights stored in the model may be selectively accommodated or modified based on comparison between the inferences generated by the model and the labels.

Instead of identifying the training data by the single classification model, the plurality of classes are categorized into the plurality categories and the models respectively corresponding to the categories are trained. Since the models are trained to distinguish whether the training data falls within the corresponding category, and the number of classes covered by each model is less than that covered by the classification model, identifying the training data by the plurality of models may effectively improve model complexity, and thereby lowering computing power and latency. In addition, these models can be executed in parallel independently, which brings better system adaptability.

FIG. 2B illustrates a schematic diagram on a classification result CR generated by the models M1-M3 in accordance with some embodiments of the present disclosure. In the exemplary embodiment, a classification model CM is configured to generate the classification result CR to identify the nine classes as described in above paragraphs related to FIG. 2A according to the training data. In addition, the classification comprises three models M1-M3, which respectively corresponds to the categories CG1-CG3 as divided in FIG. 2A. The model M1 corresponds to the animal category CG1, the model M2 corresponds to the vehicle category CG2, and the model M3 corresponds to the flower category CG3.

The classification result CR comprises a plurality probability values P11-P33 respectively corresponding to the nine classes. The model M1 is configured to generate three probability values PI 1-P33 respectively corresponding to the three classes C11-C13 of the animal category CG1. The model M2 is configured to generate three probability values P21-P23 respectively corresponding to the three classes C21-C23 of the animal category CG2. The model M3 is configured to generate three probability values P31-P33 respectively corresponding to the three classes C31-C33 of the animal category CG3. Each of the probability value P11-P33 shows a probability value determined by the models M1-M3 on how much percentage an object of the corresponding class is appeared in the training data.

In addition, the classification result CR further comprises category probability values CP1-CP3 respectively corresponding to the categories CG1-CG3. The category probability values CP1-CP3 are respectively generated by the models M1-M3, to show probability values on how much percentage that objects of the corresponding categories are not appeared in the training data. For example, the category probability value CP1 generated by the model M1 shows the percentage on how much the animal category CG1 is not appeared in the training data. Therefore, the category probability value CP1 and a summation of the probability values P11-P13 are complementary. In other words, the summation of the probability values P11-P13 and the category probability value CP1 generated by the same model M1 equals to 1. Similarly, the category probability value CP2 and a summation of the probability values P21-P23 are also complementary, and the summation of the probability values P21-P23 and the category probability value CP2 generated by the same model M2 equals to 1. The category probability value CP3 and a summation of the probability values P31-P33 are also complementary, and the summation of the probability values P31-P33 and the category probability value CP3 generated by the same model M3 equals to 1. However, other configurations of the category probability values are also within the scope of various embodiments. For example, the category probability values CP1-CP3 may show probability values on how much percentage that objects of the corresponding categories are appeared in the training data. Under such a circumstance, the category probability value CP1 equals to a summation of the probability values C11-C13 within the same category.

In some embodiments, evaluation of the category probability values CP1-CP3 may be performed prior to evaluation of the probability values P11-P33. Instead of examine and compare all the probability values P11-P33 at once to find out to which class the training data corresponds, the category probability values CP1-CP3 may be examiner and compared first to determine a selected category which the data falls within. Then, the probability values correspond to the selected category may be examined to determine which class the data falls within. For example, when the category probability values CP1-CP3 show the percentages on how much the categories CG1-CG3 are not appeared in the training data, the selected category may be determined based on the lowest category probability value. Since the category probability value and the probability values of the same category are complementary, low category probability value represents high percentage on objects of the same category to be appeared in the data. As such, after the selected category with the lowest category probability value may be determined by evaluating the category probability values CP1-CP3, the probability values of the selected category may be evaluated to find out a selected class which the data falls in. By adding category probability values and breaking the evaluation process into two phases, it is unnecessary to go through all the probability values to find out the maximum/minimum, and the total amount of probability values required to be evaluated during entire process is effectively reduced, thereby improving the computation latency.

In addition, in order for the models M1-M3 to generate the category probability values, a category class is established for each class by merging all of the classes fall outside the corresponding category. During training, each model is configured to generate inferences on which the at least one class within the corresponding category and whether the training data falls within the corresponding category. Taking the model M1 in FIG. 2B for example, a category class (also referred as not animal class) corresponding to the category CG1 is established by merging all classes fall outside the category CG1. That is, all training data fall outside the category CG1 are assigned to the category class (i.e. the not animal class) and relabeled during training the model M1. After the training data is inputted into the model M1, the labeled class including the cat, dog, horse and not animal are inputted to the model M1 for verification. Therefore, after training, the weights stored by the model M1 may be accommodated to generate computation results on identifying that a cat, a dog, or a horse is shown in a received input data, or that no animal is shown in the input data.

In brief, a neural network is assigned to each category. Then, each neural network separately trained using the associated subset of the training set to obtain the individual model parameters.

In step S14, each model is implemented on respective accelerators. More particularly, the accelerators may be computing components of an electronic system capable of performing high performance computing (HPC). In some embodiments, the electronic system comprises a processor and a plurality of accelerators. The accelerators are coupled together and to the processor through a bus. In some embodiments, the accelerator may be a logic die (e.g., central processing unit (CPU), a graphics processing unit (GPU), a system-on-a-chip (SoC), an application processor (AP), a microcontroller (MCU), or the like). In some aspects, since each model is implemented on respective accelerators, and each model performs independent and parallel computation, less data transmission between each of the accelerators is involved in operations of the electronic system, thereby increase the computing speed of the electronic system.

In addition, each accelerator comprises a static random-access memory (SRAM) and a computing circuit. The SRAM is configured to store weights of the corresponding model. The computing circuit is configured to access the weights to generate the computation result. Due to smaller size or lower model complexity of the model obtained through steps S11-S13, the model may be stored in the SRAM rather than dynamic random-access memory (DRAM). In some embodiments, each class may be disposed on separate chips, so the computing circuit may access the SRAM within the same model to generate the computation result. In other words, each computation result may be generated by accessing the on-chip SRAM to increase computation speed of the electronic system.

With regard to generate the computation result by the single classification model, the classification model is usually implemented on an electronic system with multiple cores, and thus the computation result of each core is required to be accessed and shared with each other to generate computation result of the classification model. Therefore, computation speed is worsened by data transmission between core. In addition, due to greater size of the classification model, it is usually required to use the DRAM to store weights of the classification. Since the DRAM is disposed externally to the accelerators, access time between the DRAM and the accelerators also increases the computation speed.

In some aspects, the design method may categorize the classes to be identified into a plurality of categories, so the plurality of models respectively corresponding to plurality of categories with shallower model complexity may be obtained through training. These models may be implemented on separated accelerators, and thus the weights may be stored in the SRAMs disposed internally in the accelerator, which leads to faster access of the weights. In some aspects, since these models perform independent computations, less data transmission between the accelerators is involved, which leads to less computing latency. In addition, due to the smaller model complexity, overall computing speed and power consumption are improved as well.

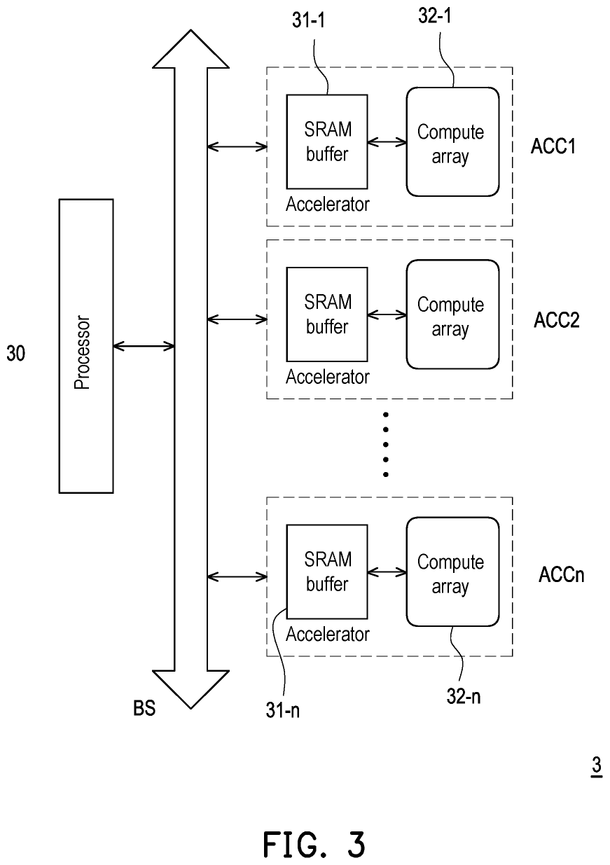

FIG. 3 illustrates an electronic system 3 in accordance with some embodiments of the present disclosure. The electronic system 3 comprises a processor 30, accelerators ACC1-ACCn. and a bus BS connecting the processor 30 and the accelerators ACC1-ACCn. Each accelerator comprises an SRAM and a computing circuit. For example, the accelerator ACC1 comprises an SRAM 31-1 and a computing circuit 32-1, the accelerator ACC2 comprises an SRAM 31-2 and a computing circuit 32-2, etc. The electronic system 3 stores the plurality of models being trained as described in the above paragraphs related to FIGS. 1-2B. The plurality of models are respectively stored by the accelerators ACC1-ACCn and executed to generate the classification result comprising probability values. More particularly, each model corresponds to a category with at least one class being categorized within, and each accelerator is configured to store a corresponding category. Therefore, upon receiving of a data, each accelerator generates a classification result on whether the data falls within the corresponding category.

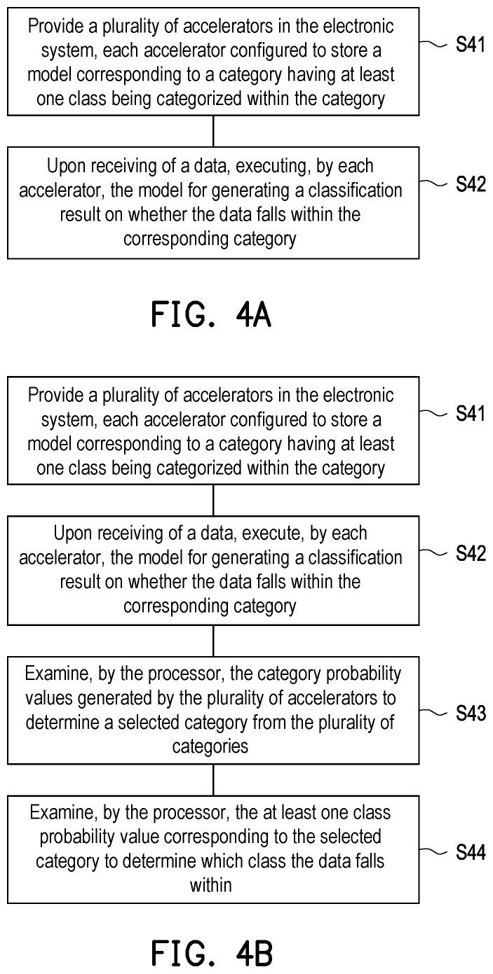

FIG. 4A illustrates an operating method of and electronic system in accordance with some embodiments of the present disclosure. The operating method comprises steps S41, S42. The operating method as illustrated in FIG. 4A may be implemented on the electronic system storing the models being trained as illustrated in FIG. 1. In some embodiments, the operating method may be implemented on the electronic system 3 as illustrated as FIG. 3. Please refer to FIGS. 1, 3. 4A together to better understand descriptions about the operating method in the following paragraphs.

In step S41, a plurality of accelerators ACC1-ACCn are provided in an electronic system 3, and each accelerator ACC1-ACCn is configured to store a model corresponding to a category with at least one class being categorized within the category. Specifically, a static random-access memory (SRAM) and a computing circuit coupled to the SRAM are provided in each accelerator, and a processor 30 coupled to the accelerators through a bus BS are provided in the electronic system 3. The plurality of models are respectively stored in the SRAM of the plurality of accelerators. Since the classes to be identified are divided into a plurality of categories and the categories are respectively used to train the models, the plurality of accelerators storing the plurality of models respectively corresponds to the plurality of categories.

In step S42, upon receiving of a data, each accelerator executes the model stored therein for generating a classification result on whether the data falls within the corresponding category. The classification result generated by the accelerators comprises the plurality of probability values respectively corresponding to the plurality of classes. Specifically, the computing circuit in each accelerator may access the SRAM to obtain parameters of the model, so the computing circuit may execute each model for identification. Each accelerator is configured to execute the corresponding model for determining whether the received data falls within the at least one class of the corresponding category. Each accelerator is configured to generate at least one probability values of the at least one classes within the corresponding category. Each probability value may show determination on how much percentage an object of the corresponding class is appeared in the data. Therefore, each probability value of the classification result may be utilized by the processor for evaluating whether object of each class is appeared in the data.

FIG. 4B illustrates an operating method of and electronic system in accordance with some embodiments of the present disclosure. The operating method comprises steps S41-S44. The operating method as illustrated in FIG. 4B may be implemented on the electronic system storing the models being trained as illustrated in FIG. 1. In some embodiments, the operating method may be implemented on the electronic system 3 as illustrated as FIG. 3. Please refer to FIGS. 1, 3, 4B together to better understand descriptions in the following paragraphs.

In step S41, a plurality of accelerators ACC1-ACCn are provided in an electronic system 3, and each accelerator ACC1-ACCn is configured to store a model corresponding to a category with at least one class being categorized within the category. Specifically, a static random-access memory (SRAM) and a computing circuit coupled to the SRAM are provided in each accelerator, and a processor 30 coupled to the accelerators through a bus BS are provided in the electronic system 3. The plurality of models are respectively stored in the SRAM of the plurality of accelerators. Since the classes to be identified are divided into a plurality of categories and the categories are respectively used to train the models, the plurality of accelerators storing the plurality of models respectively corresponds to the plurality of categories.

In step S42, upon receiving of a data, each accelerator executes the model stored therein for generating a classification result on whether the data falls within the corresponding category. The classification result generated by the accelerators comprises the plurality of probability values respectively corresponding to the plurality of classes. Specifically, the computing circuit in each accelerator may access the SRAM to obtain parameters of the model, so the computing circuit may execute each model for identification. Each accelerator is configured to execute the corresponding model for determining whether the received data falls within the at least one class of the corresponding category. Each accelerator is configured to generate at least one probability values of the at least one classes within the corresponding category. Each probability value may show determination on how much percentage an object of the corresponding class is appeared in the data. Therefore, each probability value of the classification result may be utilized by the processor for evaluating whether object of each class is appeared in the data.

In some embodiments, in addition to generating the at least one probability value corresponding to the at least one class within the corresponding category, each accelerator is further configured to generate a category probability value of the corresponding category. Specifically, the computing circuit of each accelerator is configured to generate each category probability value to show determination on how much percentage an object of the corresponding category is appeared in the data. That is, each accelerator is configured to generate the at least one probability value respectively corresponding to the at least one class within the category and the category probability value of the corresponding category.

In step 543, the processor 30 examines the category probability values generated by the plurality of accelerators to determine a selected category which the data falls within from the plurality of categories. Specifically, the processor 30 may obtain the category probability values to evaluate possibilities of all categories to determine a selected category. The category with the highest percentage that objects of the at least one class within the corresponding category is appeared in the data is determined as the selected category.

In step S44, the processor 30 examines the at least one class probability value corresponding to the selected category to determine which class the data falls within. That is, the processor 30 may determine the selected category first, and then look into the probability values of the selected category to find out objects of what class within the selected category is appeared in the data. As such, the processor 30 may determine objects of which class is most likely to shown in the data without going through all the probability values.

In some embodiments, the category probability value shows a probability value on how much percentage on objects of the corresponding category is not appeared in the training data. As such, the category probability value and a summation of all probability values of the same category are complementary. That is, a summation of the category probability value and the probability values generated by the same accelerator equals to 1. The higher the category probability value is, the lower chance objects of the at least one class within the category are shown in the data. On the contrary, the lower the category probability value is, the higher chance objects of the at least one class within the category are shown in the data. As such, the processor 30 may obtain the probability values generated by all accelerators ACC1-ACCn to find the selected category with the lowest category probability value. Then, the processor 30 may further evaluate the at least one probability value of the selected category to find out what objects of which class is most likely to shown in the data.

In some embodiments, the category probability value shows a probability value on how much percentage on objects of the corresponding category is appeared in the training data. As such, the category probability value and a summation of all probability values of the same category are the same. The higher the category probability value is, the better chance objects of the at least one class within the category are shown in the data. On the contrary, the lower the category probability value is, the less chance objects of the at least one class within the category are shown in the data. As such, the processor 30 may obtain the probability values generated by all accelerators ACC1-ACCn to find the selected category with the highest category probability value. Then, the processor 30 may further evaluate the at least one probability value of the selected category to find out objects of which class is most likely shown in the data.

In an aspect, the disclosure is directed to a design method of an accelerator, and the method includes receiving a training dataset having a plurality of training data, wherein each training data is labeled to one of a plurality of classes; selecting at least one first class from the plurality of classes and establishing a first category having the at least one selected first class; training a first model with the training dataset, and using the at least one first class within the first category for verification; and implementing the first model on the accelerator.

According to an exemplary embodiment, upon receiving of each training data, the trained first model is configured to generate at least one first probability value respectively corresponding to the at least one first class, for inferring percentages an object of the at least one class is shown in each training data. According to an exemplary embodiment, upon receiving of each training data, the trained first model is further configured to generate a first category probability value, for inferring a percentage whether objects of the first category is shown in each training data. According to an exemplary embodiment, a summation of the first category probability value and the at least one first probability value equals to 1. According to an exemplary embodiment, training the first model with the training dataset and using the at least one class falls within the first category for verification would include establishing a first category class by merging all classes fall outside of the first category; training the with the training dataset; and verifying the first model by using the first category class and the at least one first class.

In an aspect, the disclosure is directed to an electronic system which includes a processor; and a plurality of accelerators, coupled to the processor, each accelerator being configured to store a model corresponding to one of a plurality of categories with at least one class being categorized within the category, wherein each accelerator is configured to perform: upon receiving of a data, executing the model for generating a classification result to infer whether the data falls within the corresponding category.

According to an exemplary embodiment, each of the accelerator may include a SRAM, configured to store the corresponding model; and a computing circuit, coupled to the SRAM, the computing circuit being configured to access the SRAM in order to execute the corresponding model for generating the classification result upon receiving of the data. According to an exemplary embodiment, each classification result may include at least one probability value, each accelerator is configured to generate the at least one probability value respectively corresponding to the at least one class within the corresponding category upon receiving of the data, for inferring which of the at least one class the received data falls within. According to an exemplary embodiment, each classification result further includes a category probability value, each accelerator is configured to generate the category probability value upon receiving of the data, for inferring whether the data falls within the category. According to an exemplary embodiment, a summation of the category probability value and the at least one probability value of each classification result equals to 1.

According to an exemplary embodiment, upon receiving of the data, the processor may be configured to examine the category probability values generated by the plurality of accelerators to determine a selected category from the plurality of categories and examine the at least one class probability value corresponding to the selected category to determine which class the data falls within. According to an exemplary embodiment, a category accelerator of the plurality of accelerators is configured to store a category model, and the category accelerator is configured to perform: upon receiving of the data, executing the category model for generating a plurality of category probability values respectively corresponding to the plurality of categories to infer which category the data falls within. According to an exemplary embodiment, after the category probability values are generated, the processor is configured to determine a selected category from the plurality of categories according to the category probability values. According to an exemplary embodiment, after the selected category is determined, the model corresponding to the selected category is configured to receive the data and generate at least one probability value respectively corresponding to at least one class within the selected category for inferring which class of the selected category the data falls within.

The disclosure is direct to an operating method of an electronic system, including providing a plurality of accelerators in the electronic system, each accelerator being configured to store a model corresponding to one of a plurality of categories with at least one class being categorized within the category; and upon receiving of a data, executing, by each accelerator, the model for generating a classification result to infer whether the data falls within the corresponding category.

According to an exemplary embodiment, the system would provide a SRAM configured to store the corresponding model, and a computing circuit in each accelerator, coupled to the SRAM and configured to access the SRAM to generate the classification result upon receiving of the data. According to an exemplary embodiment, each classification result would include at least one probability value, and the operating method includes generating, by each accelerator, the at least one probability value respectively corresponding to the at least one class falls within the corresponding category upon receiving of the data, for inferring which of the at least one class the received data falls within. According to an exemplary embodiment, each classification result further includes a category probability value, the operating method includes generating, by each accelerator, the category probability value upon receiving of the data, for inferring whether the data falls within the category. According to an exemplary embodiment, a summation of the category probability value and the at least one probability value of each classification result equals to 1. According to an exemplary embodiment, upon receiving of the data, examining, by the processor, the category probability values generated by the plurality of accelerators to determine a selected category which the data falls within; and examining, by the processor, the at least one class probability value corresponding to the selected category to determine which class the data falls within.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A design method of an accelerator, comprising:
receiving a training dataset having a plurality of training data, wherein each training data is labeled to one of a plurality of classes;
selecting at least one first class from the plurality of classes and establishing a first category having the at least one selected first class;
training a first model with the training dataset, and using the at least one first class within the first category for verification; and
implementing the first model on the accelerator.

2. The design method of claim 1, wherein upon receiving of each training data, the trained first model is configured to generate at least one first probability value respectively corresponding to the at least one first class, for inferring percentages an object of the at least one class is shown in each training data.

3. The design method of claim 2, wherein upon receiving of each training data, the trained first model is further configured to generate a first category probability value, for inferring a percentage whether objects of the first category is shown in each training data.

4. The design method of claim 3, wherein a summation of the first category probability value and the at least one first probability value equals to 1.

5. The design method of claim 1, wherein the step of training the first model with the training dataset and using the at least one class falls within the first category for verification comprising:
establishing a first category class by merging all classes fall outside of the first category;
training the with the training dataset; and
verifying the first model by using the first category class and the at least one first class.

6. An electronic system, comprising:
a processor; and
a plurality of accelerators, coupled to the processor, each accelerator being configured to store a model corresponding to one of a plurality of categories with at least one class being categorized within the category, wherein each accelerator is configured to perform:
upon receiving of a data, executing the model for generating a classification result to infer whether the data falls within the corresponding category.

7. The electronic system of claim 6, wherein each of the accelerator comprises:
a static random-access memory (SRAM), configured to store the corresponding model; and
a computing circuit, coupled to the SRAM, the computing circuit being configured to access the SRAM in order to execute the corresponding model for generating the classification result upon receiving of the data.

8. The electronic system of claim 6, wherein each classification result comprises at least one probability value, each accelerator is configured to generate the at least one probability value respectively corresponding to the at least one class within the corresponding category upon receiving of the data, for inferring which of the at least one class the received data falls within.

9. The electronic system of claim 8, wherein each classification result further comprises a category probability value, each accelerator is configured to generate the category probability value upon receiving of the data, for inferring whether the data falls within the category.

10. The electronic system of claim 9, wherein a summation of the category probability value and the at least one probability value of each classification result equals to 1.

11. The electronic system of claim 9, wherein the processor is configured to perform:
upon receiving of the data, examining the category probability values generated by the plurality of accelerators to determine a selected category from the plurality of categories; and
examining the at least one class probability value corresponding to the selected category to determine which class the data falls within.

12. The electronic system of claim 9, wherein a category accelerator of the plurality of accelerators is configured to store a category model, and the category accelerator is configured to perform:
upon receiving of the data, executing the category model for generating a plurality of category probability values respectively corresponding to the plurality of categories to infer which category the data falls within.

13. The electronic system of claim 12, wherein after the category probability values are generated, the processor is configured to determine a selected category from the plurality of categories according to the category probability values.

14. The electronic system of claim 13, wherein after the selected category is determined, the model corresponding to the selected category is configured to receive the data and generate at least one probability value respectively corresponding to at least one class within the selected category for inferring which class of the selected category the data falls within.

15. An operating method of an electronic system, comprising:
providing a plurality of accelerators in the electronic system, each accelerator being configured to store a model corresponding to one of a plurality of categories with at least one class being categorized within the category; and
upon receiving of a data, executing, by each accelerator, the model for generating a classification result to infer whether the data falls within the corresponding category.

16. The operating method of claim 15, comprising:
providing a static random-access memory (SRAM) configured to store the corresponding model, and a computing circuit in each accelerator, coupled to the SRAM and configured to access the SRAM to generate the classification result upon receiving of the data.

17. The operating method of claim 15, wherein each classification result comprises at least one probability value, the operating method comprises:
generating, by each accelerator, the at least one probability value respectively corresponding to the at least one class falls within the corresponding category upon receiving of the data, for inferring which of the at least one class the received data falls within.

18. The operating method of claim 17, wherein each classification result further comprises a category probability value, the operating method comprises:
generating, by each accelerator, the category probability value upon receiving of the data, for inferring whether the data falls within the category.

19. The operating method of claim 18, wherein a summation of the category probability value and the at least one probability value of each classification result equals to 1.

20. The operating method of claim 18, comprising:
upon receiving of the data, examining, by the processor, the category probability values generated by the plurality of accelerators to determine a selected category which the data falls within; and
examining, by the processor, the at least one class probability value corresponding to the selected category to determine which class the data falls within.
